(19) United States
(12) Patent Application Publication
(10) Pub. No.: US 2011/0228855 A1
(43) Pub. Date: Sep. 22, 2011

(54) Device for Encoding Video Data, Device for Decoding Video Data, Stream of Digital Data

(76) Inventors: Yongying Gao, Beijing (CN); Yuwen Wu, Beijing (CN); Charles Chuanming Wang, Philadelphia, PA (US)

(21) Appl. No.: 12/448,491

(22) PCT Filed: Dec. 25, 2006
(86) PCT No.: PCT/CN2006/003564

§ 371 Date: Jan. 24, 2011

(51) Int. Cl. H04N 7/26

(52) U.S. Cl. 375/240.18; 375/240.25; 375/240.01; 375/E07.226; 375/E07.027

(57) ABSTRACT

The invention concerns a device for encoding video data, a device for decoding video data and a digital stream of video data. According to the invention, the encoding device comprises—means for encoding color information related to said video data according to one layer of a scalable model, —means for encoding transformation data enabling to obtain any level of said scalable model of color information from said one layer.

### FIELD OF THE INVENTION

The invention concerns a method and a device to encode video data, a device for decoding video data and a stream of digital data.

### BACKGROUND OF THE INVENTION

More precisely the invention is related to the encoding and decoding of color information in a scalable manner.

In recent years, many manufacturers are aiming at handling color information surpassing 8-bit at every aspect of the digital imaging pipeline, including digital capturing devices, pixel display devices, and digital interface standards. The state-of-the-art video coding technologies are also pushing ahead high bit depth coding. JVT standardized the high bit depth encoding, which is defined in H.264 Fidelity Range Extensions (FRExt) and currently supports the bit-depth up to 14 bits per sample (14-bit).

However, none of the existing high bit encoding techniques supports color bit depth scalable solution. Color bit depth scalability is potentially useful considering the fact that, in a considerably long period of time in the future, conventional eight bit depth and high bit depth digital imaging systems will simultaneously co-exist in consumer marketplaces. For instance, the following application issue becomes common when there are display devices that support different bit depths. Assume that two clients that have an 8-bit display device and a 12-bit display device respectively request for a raw video. To best match the performance of the terminal display, two versions of 8-bit and 12-bit are provided accordingly. Without scalable solution, it is necessary to encode the two versions separately to generate two bit streams. For the content delivery, one has to simulcast in a network or a communication channel, or put the 2 bit streams in one disk. Both ways are of low efficiency regarding both the compression ratio and the operational complexity. Another possible solution is to encode only the 12-bit version by H.264 FRExt profiles. At the client end, an 8-bit video can be extracted from the decoded 12-bit video. However, there are two drawbacks of this solution: first, both clients must have the H.264 high profile decoder to decode and display the video regardless whether 8-bit or 12-bit video is wanted; secondly, if the relationship between the 8-bit and 12-bit video is rather than truncation of the four least bits from the 12-bit video, extracting an 8-bit video from the decoded 12-bit video may cause video quality degradation, known as banding effects. Color bit depth scalable coding arrives at a balance among the coding efficiency, operation complexity and the flexibility.

### SUMMARY OF THE INVENTION

To overcome at least one of these drawbacks, the invention proposes a device for encoding video data. According to the invention, the device comprises
means for encoding color information related to said video data according to one layer of a scalable model,
means for encoding transformation data enabling to obtain any level of said scalable model of color information from said one layer.

In a preferred embodiment, said transformation data are related to at least one mathematical model.

Preferentially, said encoding is done in accordance with JVT-U201 standard.

In an advantageous embodiment, transformation data are encapsulated within a Supplemental Enhancement Information (SEI) message.

In a preferred embodiment, said message is inserted regularly or irregularly in the data stream, said transformation data comprised in said message being used for the prediction of the images following said inserted message until a new message is inserted.

Preferentially, said one layer corresponds to the low level layer, said scalability model layers corresponding each to the bit depth used for encoding said color information.

Preferentially, the mathematical model is chosen between:
a piecewise linear curve between the low bit depth layer and the high bit depth layer,
a polynomial function between the low bit depth layer and the high bit depth layer,
a lookup table that maps each value within a low bit depth data range and a high bit depth data range.

The invention concerns also a system for decoding a bit stream of video data; According to this aspect of the invention, the system comprises
means for extracting from said bitstream, a color-encoded data encoded according to one base layer,
means for decoding said one base layer encoded data,
means for decoding color-encoded data encoded according to another layer from said color_encoded data encoded according to said base layer and from one message comprised in said bitstream.

In a preferred embodiment the system comprises means to decode from said bit_stream at least one Supplemental Enhancement Information message related to color_bit_depth encoding of the data_stream.

According to another aspect, the invention concerns also a stream of digital data. According to this aspect of the invention, the stream of digital data comprises
a set of encoded video data being coded according to a layer of a color model comprising several layers,
code information enabling to obtain said set of data coded according to at least another level of the color model.

### BRIEF DESCRIPTION OF THE DRAWINGS

Other characteristics and advantages of the invention will appear through the description of a non-limiting embodiment of the invention, which will be illustrated, with the help of the enclosed drawing.

FIG. 1 represents one system comprising an encoding and a decoding device according to a preferred embodiment of the invention,

FIGS. 2a, 2b and 2c illustrate some mathematical models used in a two layers color bit-depth scalable model,

### DETAILED DESCRIPTION OF THE PREFERRED EMBODIMENTS

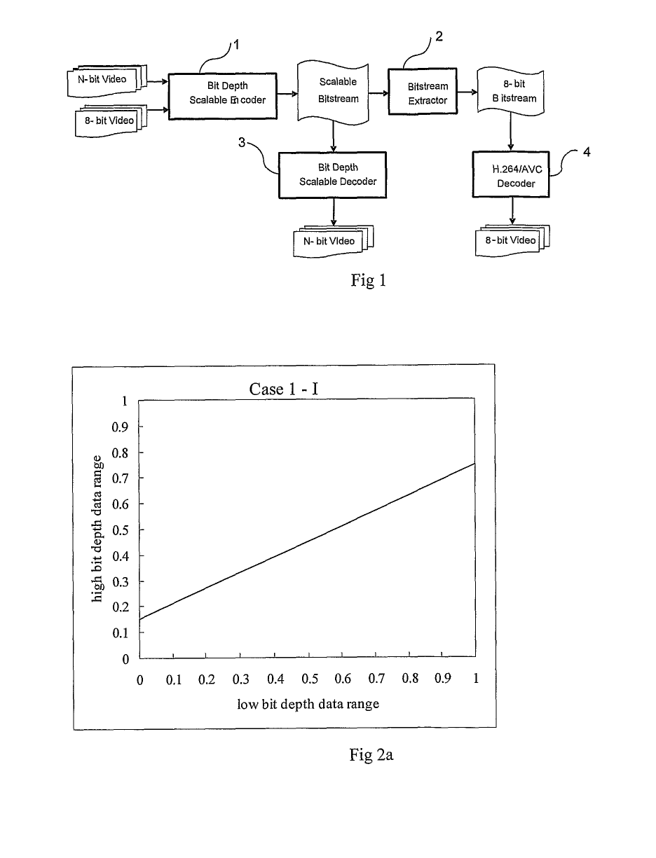

FIG. 1 represents a system comprising both the encoding device 1 and the decoding device 3 implementing a preferred embodiment of the invention.

In the preferred embodiment described in reference to FIG. 1, a coding scheme compliant with JVT-U201 standard is proposed. JVT-U201 corresponds to H.264/AVC scalable extension (SVC).

One aim of the invention is to be able to encode one video data intended to be displayed on several high-end devices which supported color bit depth is different from one device to the other, without sending a plurality of video data.

In this preferred embodiment, a new Supplemental Enhancement Information (SEI) message is defined for sending color scalability information.

This message comprises transformation data enabling to obtain any level of the scalability model from the encoded level. To this end, the SEI message comprises one or a plurality of mathematical models describing how to predict one layer from another layer. Typically, the low layer being the layer which needs the less information to be coded, therefore which requires the less bandwidth, the low level data are encoded and the SEI message comprises the mathematical model to get the upper layers from the low level layers.

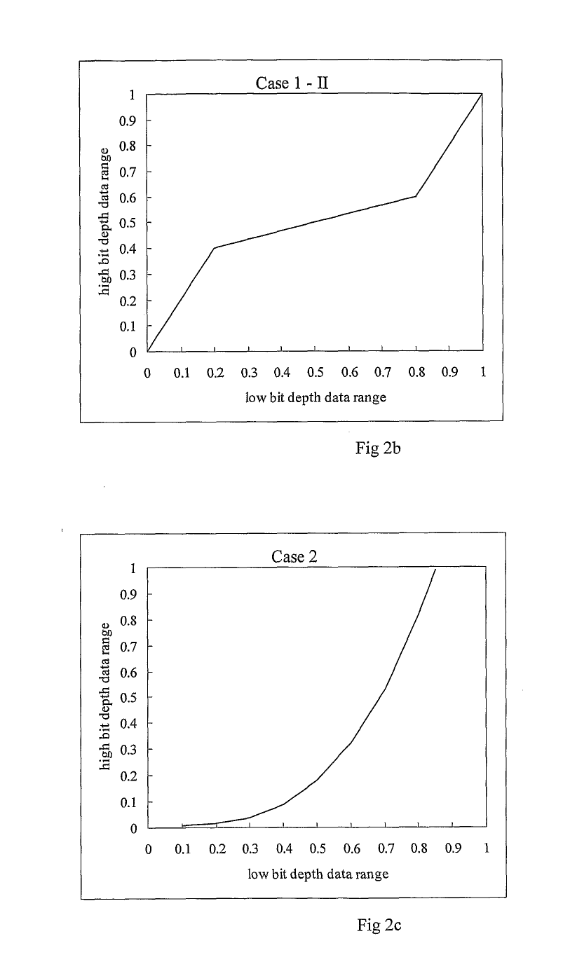

The mathematical models are described in reference to FIGS. 2a, 2b and 2c. These figures represent the low bit depth and the high bit depth both comprised in a range [0,1]. This is only a schematic representation and has to be translated in a real scale. For instance, when the low bit depth is 8 bits, which is usually the case, the high bit depth can go from 9 bits depth until 14 bits depth as far as H264 is concerned, and mainly an even number such as 10, 12 or 14 bits depth.

FIG. 2a represents a piecewise linear curve, which is the simplest model that can be envisaged.

FIG. 2b represents another type of piecewise linear curve, comprising three segments of different gradient

FIG. 2c represents another mathematical model based on a polynomial function between the low bit depth data and the high bit depth data.

Next table gives an embodiment of the SEI message used for encapsulating the scalable color information mathematical models.

| bit_depth_pred( playloadSize ) { | C | Descriptor |
|---|---|---|
| bit_depth_pred_id | 5 | u(8) |
| low_bit_depth | 5 | u(8) |
| high_bit_depth | 5 | u(8) |
| case_id | 5 | ue(v) |
| if( case_id == 0 ) { | | |
| for( i=0; i < (1<<low_bit_depth); i++ ) { | | |
| high_mapped_value [ i ] | 5 | u(v) |
| } | | |
| } | | |
| if( case_id == 1) { | | |
| num_joints | 5 | ue(v) |
| for( i=0; i<num_joints; i++ ) { | | |
| low_joint_value[ i ] | 5 | u(v) |
| high_joint_value[ i ] | 5 | u(v) |
| } | | |
| } | | |
| If( case_id == 2 ) { | | |
| num_items | 5 | ue(v) |
| for( i=0; i<num_items; i++ ) { | | |
| item_power[ i ] | 5 | se(v) |
| item_coefficient[ i ] | 5 | se(v) |
| Item_coefficient_base[ i ] | 5 | ue(v) |
| } | | |
| } | | |
| } | | |

bit_depth_pred_id specifies the associated high bit depth layer that this SEI message applies to. The value of bit_depth_pred_id is derived from the identifier of the associated high bit depth layer. The associated low bit depth layer may be from the slice_header_in_scalable_extension( ) of the associated high bit depth layer.

low_bit_depth specifies the bit depth of the low bit depth image from which a predicted version of the high bit depth image is generated.

high_bit_depth specifies the bit depth of the high bit depth image.

case_id specifies the mathematical model that is utilized to predict the high bit depth image from the low bit depth image.
a case_id of 0 corresponds to a lookup table that maps each value within the low bit depth data range to a value within the high bit depth data range,
a case_id of 1 corresponds to a piecewise linear curve between the low bit depth data and the high bit depth data;
a case_id of 2 corresponds to a polynomial function between the low bit depth data and the high bit depth data;

The next defined field corresponds to a look-up table correspondence between the low bit depth and the high bit depth, used only when case_id is equal to “0”.

high_mapped_value[i] specifies the value within the high bit depth data range that the value i within the low bit depth data range is mapped to. The number of bits that are used for representing the high_mapped_value is high_bit_depth.

The next defined fields correspond to a piecewise linear function between the low bit depth and the high bit depth, used only when case_id is equal to “1”.

num_joints specifies the number of joints in the piecewise linear curve.

low_joint_value[i] specifies the value in the low bit depth data corresponding to the i-th joint. The number of bits that are used for representing the low_joint_value is low_bit_depth.

high_joint_value[i] specifies the value in the high bit depth data corresponding to the i-th joint. The number of bits that are used for representing the high_joint_value is high_bit_depth.

The next defined fields correspond to a polynomial function between the low bit depth and the high bit depth, used only when case_id is equal to “2”.

num_items specifies the number of the items in the polynomial function.

item_power[i] specifies the power of the i-th item in the polynomial function.

item_coefficient[i] specifies the numerator of the coefficient of the i-th item in the polynomial function.

item_coefficient_base[i] specifies the base that is used to derive the coefficient of the i-th item in the polynomial function. The coefficient of the i-th item in the polynomial function is obtained by item_coefficient[i]/2^{item}^{_{—}}^{coefficient}^{_{—}}^{base[i].}

The power and the coefficient of each item of this polynomial are transmitted in a descending order of the power.

This SEI message is inserted in the data stream by the encoder. One access unit may contain multiple bit depth prediction SEI messages that apply to different bit depth layers. The semantics of one bit depth prediction SEI message are valid until the presence of next bit depth prediction SEI message of the same bit_depth_pred_id.

One SEI message is relative to the NAL (standing for Network Adaptation Layer) units following this message, until a new SEI message is detected which will concern the NALs coming after. Therefore, it is possible to specify different bit-depth predictions for different NAL units as the bit_depth prediction is defined in the SEI message.

In the defined H.264/AVC scalable extension (SVC) standard, each layer is identified by a set of identifiers. Also, for each layer, its base picture is also identified by an identifier. Hence, at the decoder side, the decoded slice can correctly find its corresponding bit depth prediction SEI message according to the syntax element bit_depth_pred_id.

Back to FIG. 1, a bit-depth scalable encoder is used for encoding the video data according to an 8 bit-depth color layer and also encapsulating the mathematical model to be used to obtain the video data coded according to another bit_depth color layer.

The bit-depth encoder provides a scalable encoded bitstream. Once received for being decoded and used, the scalable encoded bitstream is received on a bit stream extractor 2. The bit stream extractor 2 is in charge of separating the low layer bit stream from the scalable bit-stream. The extracted low layer bit stream is then decoded by a compliant H.264 decoder 4 in order to obtain the 8-bit colour encoded bit stream.

The n-bit depth color encoded bit-stream is sent to a bit depth scalable decoder 3.

1. Device for encoding video data wherein it comprises
means for encoding color information related to said video data according to one layer of a scalable model,
means for encoding transformation data enabling to obtain any level of said scalable model of color information from said one layer.

2. Device according to claim 1 wherein said transformation data are related to at least one mathematical model.

3. Device according to claim 1 wherein said encoding is done in accordance with JVT-U201 standard.

4. Device according to claim 1 wherein said transformation data are encapsulated within a Supplemental Enhancement Information message.

5. Device according to claim 4 wherein said message is inserted regularly or irregularly in the data stream, said transformation data comprised in said message being used for the prediction of the images following said inserted message until a new message is inserted.

6. Device according to claim 1 wherein said one layer corresponds to the low level layer, said scalability model layers corresponding each to the bit depth used for encoding said color information.

7. Device according to claim 5 wherein the mathematical model is chosen between:
a piecewise linear curve between the low bit depth layer and the high bit depth layer,
a polynomial function between the low bit depth layer and the high bit depth layer,
a lookup table that maps each value within a low bit depth data range and a high bit depth data range.

8. System for decoding a bit stream of video data wherein it comprises
means for extracting from said bitstream, a color-encoded data encoded according to one base layer,
means for decoding said one base layer encoded data,
means for decoding color-encoded data encoded according to another layer from said color_encoded data encoded according to said base layer and from one message comprised in said bitstream.

9. System for decoding a bit stream according to claim wherein it comprises means to decode from said bit_stream at least one Supplemental Enhancement Information message related to color_bit_depth encoding of the data_stream.

10. Stream of digital data wherein it comprises
a set of encoded video data being coded according to a layer of a color model comprising several layers,
code information enabling to obtain said set of data coded according to at least another level of the color model.
